(19) United States
(12) Patent Application Publication
(10) Pub. No.: US 2026/0261301 A1
(43) Pub. Date: Sep. 3, 2026

(54) EFFICIENT FREQUENCY-DOMAIN BEAMFORMING

(71) Applicant: CesiumAstro, Inc., Austin, TX (US)

(72) Inventors: James Wesley McCoy, Liberty Hill, TX (US); Thomas Magesacher, Austin, TX (US)

(21) Appl. No.: 19/553,760

(22) Filed: Mar. 2, 2026

Related U.S. Application Data
(60) Provisional application No. 63/765,756, filed on Mar. 2, 2025.

(51) Int. Cl. H04B 7/06; H04L 27/26

(52) U.S. Cl. CPC H04B 7/0617; H04L 27/2628; H04L 27/265

(57) ABSTRACT

The present disclosure provides for digital beamforming using a first interface coupled to an analog front end, a second interface coupled to a signal processing circuit, and a beamforming circuit coupled to the first and second interfaces. The beamforming circuit may be configured to receive I-Q samples for B beams or C′ channels and determine a Fast Fourier Transform (FFT) for the I-Q samples for each beam or for each channel to determine vector signals. The circuit may be configured to multiply filter coefficients and the vector signals to produce output signals, combine the output signals entering a given channel and determine an inverse FFT for the output signals to produce a time-domain signal. The circuit may be configured to perform an overlap/add operation on the time-domain signal to produce an output signal and provide the output signal to one of the first interface or the second interface.

### CROSS-REFERENCE TO RELATED APPLICATIONS

This application claims the benefit of U.S. Provisional Application No. 63/765,756, filed on Mar. 2, 2025, which is hereby incorporated by reference in its entirety.

### TECHNICAL FIELD

The present disclosure is generally related to digital signal processing, and in at least one embodiment to digital beamforming using efficient Fourier transformations having reduced calculations.

### BACKGROUND

The concept of operations in wireless communication systems, such as 6^{th} Generation (5G) mobile satellite telecommunications, may require the receiving antenna array to employ beamforming operations using antenna arrays to enable communications. Beamforming refers to a process for computing adjustments to direct a phased-array antenna system to receive and transmit signals.

In general, physical space between antennas of an antenna array may result in minute delays in receiving a signal. Analog beamformers may use phase shifters to account for the delays and to make adjustments to enable beamforming. Digital beamformers may use fractional delay filters to direct the phased-array antenna system to account for the delays and to make adjustments to enable beamforming.

Digital beamforming for an antenna array requires multiple computations. The number of computations can significantly impact the process time and the power consumption of the system.

### BRIEF SUMMARY

Embodiments disclosed herein include beamforming circuitry and logic, as well as systems and devices including or utilizing such circuitry or logic, and methods or executable instructions for operating or using results of such circuitry or logic. A beamforming circuit according to at least one embodiment can be configured to utilize a Discrete Fourier transform (DFT) in conjunction with an overlap-add method to efficiently evaluate time domain channel signals and time domain beam signals. In some embodiments, the DFT may be implemented as a Fast Fourier Transform (FFT) or any other fast algorithmic variant. The beamforming circuit may receive in-phase (I) and quadrature (Q) samples for B beams (transmit mode) or C′ channels (receive mode) and may perform one FFT operation per beam (transmit mode) or per channel (receive mode) in the data path. The beamforming circuit may multiply the resulting frequency-domain beam data (transmit) or channel data (receive) by determined channel filter coefficients to produce vector products that may be combined from all beams (transmit mode) or channels (receive mode) to produce a frequency-domain channel signal (transmit) or beam signal (receive). The beamforming circuit may perform an inverse DFT per channel (transmit mode) or per beam (receive mode) on the combined vector products to produce a time-domain output and may perform an overlap/add operation on the time-domain output to produce a beam output (receive mode) or a channel output (transmit mode). In some embodiments, the inverse DFT may be implemented as an Inverse Fast Fourier Transform (IFFT) or any other fast algorithmic variant.

In some embodiments, a system may include a first input/output (I/O) interface coupled to an analog front end, a second I/O interface coupled to a signal processing circuit, and a frequency-domain beamforming circuit coupled to the first I/O interface and the second I/O interface. The frequency-domain beamforming circuit may be configured to receive in-phase and quadrature (I-Q) samples for B beams or C′ channels and determine an FFT for the I-Q samples for each beam or for each channel to determine frequency-domain vector signals. The frequency-domain beamforming circuit may be configured to multiply frequency-domain filter coefficients and the frequency-domain vector signals to produce vector output signals, combine the vector output signals entering a given channel or a given beam to produce a channel signal or a beam signal and determine an IFFT for the channel signal or the beam signal to produce a time-domain signal. The frequency-domain beamforming circuit may be configured to perform an overlap/add operation on the time-domain signal to produce an output signal and provide the output signal to one of the first I/O interface or the second I/O interface.

In some embodiments, a method of determining an output signal including one of a channel signal or a beam signal may include receiving, at a frequency-domain beamforming circuit, I-Q samples for B beams or C′ channels at one of a first I/O interface coupled to an analog front end or a second I/O interface coupled to a processing circuit. The method may include determining an FFT for the I-Q samples for each beam or for each channel to determine frequency-domain vector signals and multiplying frequency-domain filter coefficients and the frequency-domain vector signals to produce vector output signals. The method may include combining the vector output signals entering a given channel or a given beam to produce a channel signal or a beam signal and determining an IFFT for the channel signal or the beam signal to produce a time-domain signal. The method may include performing an overlap/add operation on the time-domain signal to produce an output signal and providing the output signal to one of the first I/O interface or the second I/O interface.

In still other embodiments, a system may include a first I/O interface coupled to an analog front end, a second I/O interface coupled to a signal processing circuit, and a frequency-domain beamforming circuit coupled to the first I/O interface and the second I/O interface. The frequency-domain beamforming circuit configured to receive I-Q samples for B beams or C′ channels, determine a FFT for the I-Q samples for each beam or for each channel to determine frequency-domain vector signals, and multiply frequency-domain filter coefficients and the frequency-domain vector signals to produce vector output signals. In some embodiments, the frequency-domain filter coefficients may correspond to fractional delays including phase shifts related to delays in the antenna elements, channel-equalization responses, circuit-equalization responses, channelization/separation operations, or any combination thereof. The frequency-domain beamforming circuit may be configured to combine the vector output signals entering a given channel or a given beam to produce a channel signal or a beam signal and determine an IFFT for the channel signal or the beam signal to produce a time-domain signal. The frequency-domain beamforming circuit may be configured to perform an overlap/add operation on the time-domain signal to produce an output signal and provide the output signal to one of the first I/O interface or the second I/O interface.

In a receive mode, the frequency-domain beamforming circuit may be configured to replicate the frequency-domain vector signals from the output of each of the FFTs to each of a plurality of frequency-domain filters such that the frequency-domain beamforming circuit performs one FFT operation per channel. In a transmit mode, the frequency-domain beamforming circuit is configured to perform one FFT operation per beam, sum the frequency-domain vector signals on a per element basis in the frequency domain, and reuse the IFFT for each channel before performing an overlap-add operation per channel.

### BRIEF DESCRIPTION OF THE DRAWINGS

The detailed description is set forth with reference to the accompanying figures. In the figures, the left most digit(s) of a reference number identifies the figure in which the reference number first appears. The use of the same reference numbers in different figures indicates similar or identical items or features.

FIG. 1 depicts a block diagram of a system configured to provide efficient frequency-domain beamforming, according to example embodiments;

FIG. 2 depicts a flow diagram of a method of beamforming for transmission, according to example embodiments;

FIG. 3 depicts a block diagram of functional elements of a beamforming circuit configured for transmission, according to example embodiments;

FIG. 4 depicts a flow diagram of a method of beamforming for receiving, according to example embodiments;

FIG. 5 depicts a block diagram of functional elements of a beamforming circuit configured for reception, according to example embodiments;

While embodiments are described in this disclosure by way of example, those skilled in the art will recognize that the embodiments are not limited to the examples or figures described. The figures and detailed description thereto are not intended to limit embodiments to the form disclosed, but on the contrary, the intention is to cover all modifications, equivalents, and alternatives falling within the spirit and scope as defined by the appended claims. The headings used in this disclosure are for organizational purposes only and are not meant to limit the scope of the description or the claims. As used throughout this application, the word “may” is used in a permissive sense (in other words, the term “may” is intended to mean “having the potential to”) instead of in a mandatory sense (as in “must”). Similarly, the terms “include”, “including”, and “includes” mean “including, but not limited to”.

### TECHNICAL DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Digital beamforming may require multiple computations, and the number of computations can significantly impact the power consumption of an antenna system. For example, each element of an antenna array may receive a radio frequency (RF) waveform at different times, and the system may resolve time-delays and signal interference computationally.

Embodiments suggested and disclosed herein can reduce the overall number of computations relative to conventional beamforming circuits, thereby reducing power consumption and reducing the overall computational complexity of the system. In some embodiments, a DFT operation may be implemented as Fast Fourier Transform (FFT) or any fast algorithmic variant thereof. In some embodiments, an inverse DFT operation may be implemented as Inverse Fast Fourier Transform (IFFT) or any fast algorithmic variant thereof. In some embodiments, an FFT or an IFFT may be shared such that, instead of performing multiple FFT (or IFFT) operations per channel or per beam, the FFT (or IFFT) operation may be performed once per channel or beam and the result may be shared across multiple filters. Additionally, the output of the beamforming circuit may be determined by combining all the beams entering a given channel or by combining the channels entering a given beam before performing an inverse FFT operation and an overlap/add operation. The resulting system reduces the number of operations and provides an improved, efficient beamforming circuit.

Additionally, the filters may be configured to implement phase shift, integer-sample delay, fractional-sample delay, channel equalization, circuit equalization, channelization, guard-banding, any other filtering operation required in the system, or any combination of these. For example, the filter coefficients may be determined according to the following equation:

$$h ( n ) = δ ( n - τ ) * e ( n ) * {e}^{- jp} \qquad ( 1 )$$

where n represents the discrete time index, δ(n−τ) is the impulse response of fractional-sample delay filter with delay τ, e(n) is the impulse response of an equalization filter, p is a desired phase rotation, and * denotes multiplication. The digital beamforming circuit may incorporate the fractional delays and phase shifts of the carrier into the filter coefficients in a way that corresponds to the time delay of the separate filters.

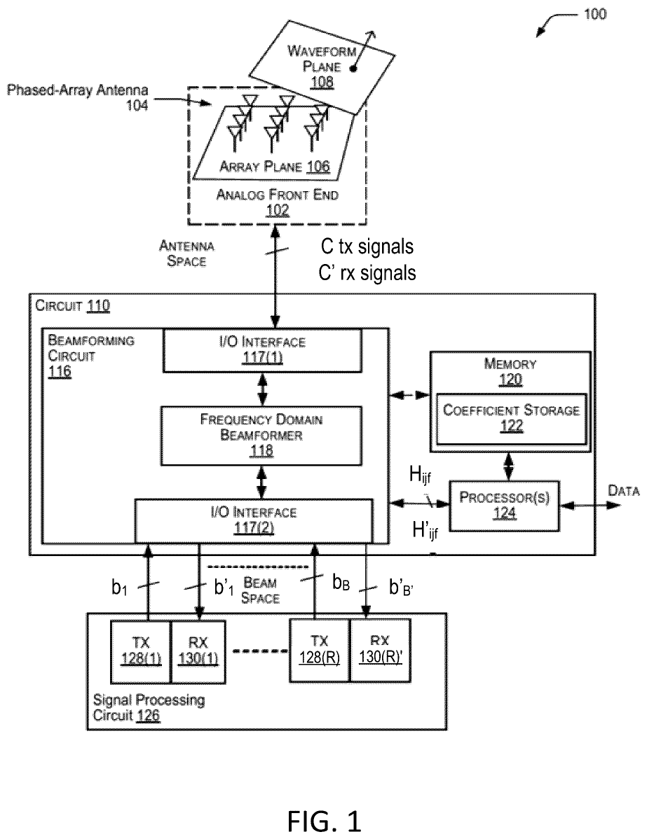

FIG. 1 depicts a block diagram of a system 100 configured to provide efficient frequency-domain beamforming, in accordance with certain embodiments of the present disclosure. The system 100 may include an analog front end 102, which may include an array plane 106 including a phased-array antenna 104 formed from a plurality of antenna elements. Each antenna element of the phased-array antenna 104 may be configured to receive and send RF signals. In an alternative implementation, the analog front end 102 may include a linear array. Each antenna element may be coupled to circuitry associated with the analog front end 102 and configured to provide signals indicative of a received RF signal. Each antenna element may also receive signals from the circuitry of the analog front end 102 and may transmit an RF signal related to the received signals to a receiving device. In some embodiments, the analog front end 102 may include or may be coupled to digital-to-analog converters (DACs), up-conversion mixers, analog-to-digital converters (ADCs), down-conversion mixers, power amplifiers, and other circuitry that may filter, amplify, phase-shift, or otherwise adjust received signals.

The circuitry associated with the analog front end 102 may be configured to receive and amplify the signals from the antenna elements and to provide signals for transmission. Additionally, the circuitry within the analog RF front end 102 may be configured to communicate signals to a circuit 110 including a beamforming circuit 116. A generated beam will have a waveform plane 108 with an orientation that is controllable by the state of the phased-array antenna 104.

In some embodiments, the circuit 110 may include or may be coupled to an analog-to-digital converter (ADC) and digital-to-analog converter (DAC), which may be coupled to the analog RF front end 102. In some embodiments, the ADC, the DAC, other circuitry, or any combination thereof may be integrated within the circuit 110 or and may be positioned between the analog front end 102 and the circuit 110. The ADC may convert analog signals from the analog front end 102 into digital data that may be processed by the circuit 110, including the beamforming circuit 116. Additionally, the DAC may convert digital data from the circuit 110, such as the beamforming circuit 116, into analog signals that may be provided to the analog front end 102 for transmission via the phased-array antenna 104.

The beamforming circuit 116 may be implemented as an application-specific integrated circuit (ASIC), a field-programmable gate array (FPGA) or a processing circuit configured to execute instructions that may be stored in a memory 120. The memory 120 may include one or more non-volatile memory devices. In some embodiments, the beamforming circuit 116 may be coupled directly to the memory 120, which may store filter coefficients in a coefficient storage 122, and the beamforming circuit 116 may retrieve the filter coefficients from the coefficient storage 122. Alternatively, the digital beamforming circuit 116 may be coupled to the memory 120 indirectly through a processor 124. In some embodiments, the processor 124 may determine the filter coefficients dynamically (on the fly). The filter coefficients may include phase shifts and fractional delays corresponding to the time delays of the various antenna elements, regardless of whether the coefficients are retrieved or calculated. In some embodiments, the processor 124 may receive data from a data source, such as another processor, an input device, or other source, and may provide the data to the digital beamforming circuit 116 for transmission.

The digital beamforming circuit 116 may provide data to or receive data from the signal processing circuit 126 or both. The signal processing circuit 126 may include one or more transmit path circuits 128 and one or more receive path circuits 130. The beamforming circuit 116 may determine B′ data streams, each of which may be provided to one of the receive path circuits 130. When sending data via the antenna array 104, the process may be reversed and the Tx path circuits 128 may provide B data streams to the beamforming circuit 116. 166 may perform transmit and receive beamforming simultaneously (in frequency-duplexed systems or full-duplex systems) or in an alternating fashion (in time-duplexed systems). In some embodiments, the memory 120, the coefficient storage 122, and the processor 124 may be part of the signal processing circuit 126. Other embodiments are also possible.

The digital beamforming circuit 116 may include one or more input/output (I/O) interfaces 117. The digital beamforming circuit 116 may include an I/O interface 117(1) coupled to elements of the phased-array antenna 104 or to one or more analog phase shifters or other analog circuits of the analog front end 102. The analog frontend 102 may process C transmit and C′ receive signals simultaneously, or alternating in time, or simultaneously or alternating in time through two array planes 106, one for transmit and one for receive. The digital beamforming circuit 116 may include an I/O interface 117(2) coupled to the processing circuit 126. Additionally, the digital beamforming circuit 116 may include a frequency-domain beamformer 118 coupled to the I/O interfaces 117(1) and 117(2). The frequency-domain beamformer 118 may utilize a shared Fast Fourier Transform (FFT) processor, a frequency-domain filter including filter coefficients that account for phase shift, fractional-sample delays, integer-sample delays, circuit equalization, channel equalization, channelization, or any other filtering operation required in the system, a shared inverse FFT, and an overlap-add method to evaluate the convolution of in-phase (I) and quadrature (Q) samples. The overlap-add method may be understood as implementing the processing described by equation 2 below:

$$y ( n ) = x ( n ) * h ( n ) \qquad ( 2 )$$

where y(n) represents the output of a digital beamforming circuit as the linear convolution of x(n) (received I-Q samples) and h(n) (filter coefficients). The overlap-add method divides the received signal into multiple convolutions of the filter coefficients and shortened segments of length L (which is an arbitrary segment length) of the I-Q data stream. The frequency-domain beam former 118 may perform FFT and inverse FFT (IFFT) processes on the received data stream.

It is known that when the discrete Fourier transform and the inverse discrete Fourier transform are implemented by the conventional FFT algorithm, the processor may perform a number M of complex multiplications for the FFT, the product of the arrays, and the IFFT, given by the following equation:

$$M = N ( {log}_{2} ( N ) + 1 ) \qquad ( 3 )$$

where N represents the length of the FFT. However, embodiments of the systems, circuits, and methods described herein may reduce the number of FFT and inverse FFT operations (or in some embodiments FFT and inverse FFT operations) per beam and per channel relative to conventional techniques. Additionally, by utilizing filter coefficients that correspond to the phase shifts and fractional delays of the antenna array 106, the number of processor calculations can be further reduced.

In some embodiments, the frequency-domain beamformer 118 may be applied to a hybrid or a full-digital beam former. In some embodiments, the channel input/output (1/O) stream may be received directly from or provided directly to antenna elements of the phased-array antenna 104. In other embodiments, the channel I/O stream may be received directly from or provided directly to analog phase shifters of the analog front end 102. Other embodiments are also possible.

In some embodiments, the frequency-domain beamforming circuit includes a first I/O interface (e.g., interface 117(1)) coupled toward the analog front end and a second I/O interface (e.g., interface 117(2)) coupled toward the signal processing circuit. In a transmit mode, after the per-channel inverse transform and overlap/add processing, the frequency-domain beamforming circuit outputs time-domain channel streams via the first interface for conversion and transmission by the analog front end. In a receive mode, after the per-beam inverse transform and overlap/add processing, the frequency-domain beamforming circuit outputs time-domain beam streams via the second interface for downstream processing by the signal processing circuit.

As used herein, the “output signal” of the frequency-domain beamforming circuit may correspond to the time-domain signal produced after the inverse transform and overlap/add processing for a given channel (transmit mode) or a given beam (receive mode). The frequency-domain beamforming circuit may provide this output signal externally through one of its interfaces depending on operating mode, thereby coupling the overlap/add result to the analog front end in transmit mode or to the signal processing circuit in receive mode.

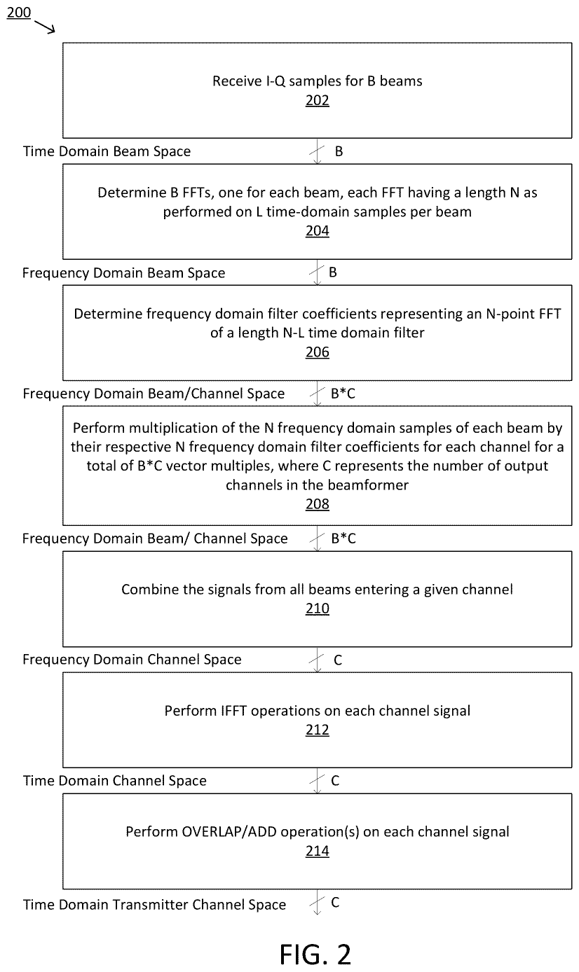

The frequency-domain beamformer circuit 118 may be used to process I-Q data streams associated with received beam samples or associated with received channel samples. An example of a method of processing I-Q samples for B beams for transmission is described below with respect to FIG. 2.

FIG. 2 depicts a flow diagram of a method 200 of beamforming for transmission, in accordance with certain embodiments of the present disclosure. The method 200 may be implemented in a field-programmable gate array (FPGA), an application-specific integrated circuit (ASIC), a programmable logic circuit, a processor circuit, or any combination thereof to perform the frequency-domain beamforming operations. In some embodiments, the beamforming operations may be defined in processor-readable instructions, which may be upgraded or altered and which may be executed by one or more processors, FPGAs, ASICs, programmable logic circuits, or other circuits of the frequency-domain beamformer circuit 118 to process the I-Q data samples.

At 202, the method 200 may include receiving I-Q data samples for B beams. The I-Q data samples may be received by the frequency-domain beamformer circuit 118 from the signal processing circuit 126, from the processor 124, or from the memory 120. The I-Q data samples are received in the time domain beam space.

At 204, the method 200 may include determining B FFTs, one for each beam, where each FFT has a length N as performed on L time-domain samples per beam. It should be understood that the FFT is a specific implementation of the DFT, and that block 204 may alternatively describe determining B DFTs of length N containing L time-domain samples per beam by any other fast algorithm. The B FFTs may be computed by the frequency-domain beamformer circuit 118. The B FFTs are provided to a multiplication filter in the frequency-domain beam space.

At 206, the method 200 may include determining frequency-domain filter coefficients representing an N point FFT of a length N−L+1 time domain filter. The frequency-domain filter coefficients may include phase shifts, fractional-sample or integer-sample delays, channel- or circuit-equalization responses, channelization filtering for user separation, or any other filter function required in the system. The frequency-domain filter coefficients may be calculated on the fly or may be retrieved from the coefficient storage 122 in the memory 120.

At 208, the method 200 may include performing a multiplication of the N frequency-domain samples of each beam by their respective N frequency-domain filter coefficients for each channel for a total of BC vector multiplies, where B represents the number of beams and C represents the number of output channels in the beamformer. In this implementation, the same frequency-domain vector is multiplied by a set of frequency-domain filter vectors so that the frequency-domain beamformer circuit 118 may perform one FFT operation per beam in the data path, instead of multiple FFTs per beam as in the prior art. The frequency-domain beamformer circuit 118 may perform the multiplications in the frequency-domain beam/channel space.

At 210, the method 200 may include combining the signals from all beams entering a given channel. In an example, each beam may include data from one or more channels, and the outputs of the multiplication operations may be organized by channel and combined. The frequency-domain beamformer circuit 118 may take the filter outputs from each of the beams and add them together on a per-element basis in the frequency domain. The resulting outputs may include streams of channel data in the frequency-domain channel space.

At 212, the method 200 may include performing an inverse FFT (IFFT) operation on each channel signal. The frequency-domain beamformer circuit 118 may perform the IFFT operations to produce a channel signal for each channel in the time domain channel space. The frequency-domain beamformer circuit 118 may reuse the IFFT for each channel.

At 214, the method 200 may include performing an overlap/add operation on each channel signal. In the overlap/add operation, the output stream of channel data of a current segment of the channel data is added to the output stream of channel data of a previous segment of the channel data. In other words, the newly processed data segment is added to the previous segment to produce proper time-domain channel data streams in the time domain transmitter channel space.

In example embodiments, B may denote a number of beams processed in transmit mode, C may denote a number of output channels produced in transmit mode, C′ may denote a number of input channels processed in receive mode, and B′ may denote a number of output beams produced in receive mode. In addition, N may denote a transform length and L may denote a time-domain segment length used for block processing (e.g., overlap/add). These symbols are exemplary and do not limit the disclosed embodiments to any particular number of beams, channels, transform lengths, or segment lengths.

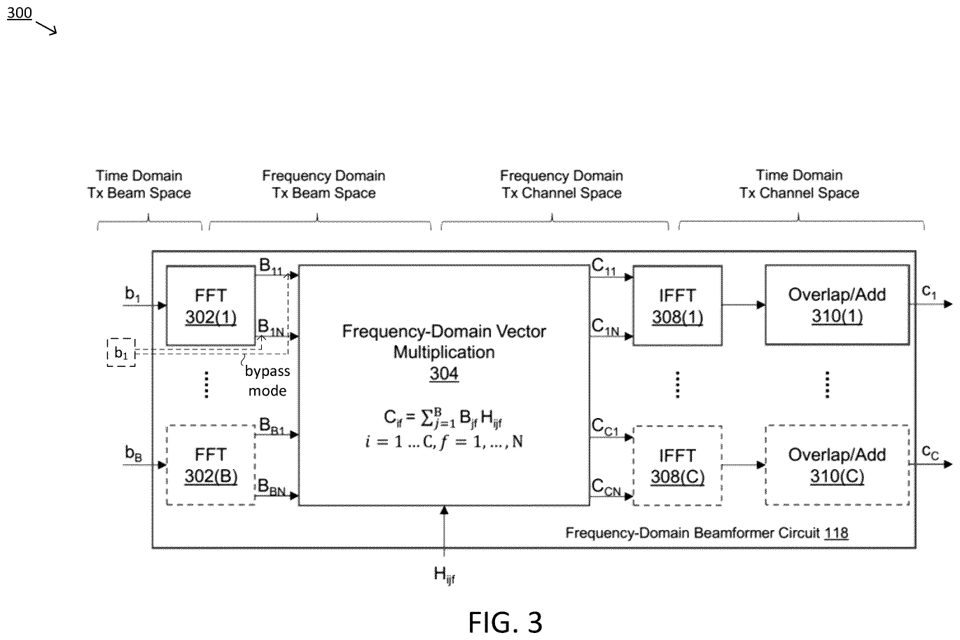

FIG. 3 depicts a block diagram a system 300 including functional elements of a frequency-domain beamforming circuit 118 configured for transmission, in accordance with certain embodiments of the present disclosure. The system 300 may include a frequency-domain beamformer circuit 118 including one or more inputs to receive I-Q time-domain samples for B beams bi, i=1, . . . , B. The frequency-domain beamformer circuit 118 may include an FFT block 302 configured to perform an FFT operation. In some embodiments, the frequency-domain beamformer circuit 118 may include an FFT block 302 for each beam. Alternatively, the FFT block 302 may be reused for each beam, depending on the implementation. In the illustrated example, the FFT block 302(1) is shown with solid lines while the FFT blocks 302(2) through 302(B) are shown in phantom because, in other embodiments, the FFT block 302 may be shared or reused for each channel.

Each FFT 302 may perform an FFT operation on segments of length L from the streams bi of I-Q samples. The FFT may have a length N including L time-domain samples per beam. The FFT 302 may provide the output to a frequency-domain vector multiplication block 304, which may provide a frequency-domain filtered output for each channel. The frequency-domain vector multiplication block 304 may receive frequency-domain filter coefficients H_{ijf} from a memory 120, a processor 124, or another source and may perform vector multiplication operations for each channel and each of the given beams. The frequency-domain vector multiplication blocks 304 may produce a vector product of B beams times C channels.

The frequency-domain beamformer circuit 118 may include a plurality of IFFT blocks 308(1) through 308(C), each of which is configured to perform an inverse FFT operation on the vector products output by the frequency domain vector multiplication blocks 304. In particular, the IFFT block 308(1) takes an input data stream from the frequency domain vector multiplication block 304 that corresponds to a channel. The output of the IFFT block 308 may include an overlap/add block 310 that may perform the overlap and add operation for each channel to produce the time-domain channel signal in the time domain transmit channel space.

In some embodiments, the frequency-domain beamformer circuit 118 may include an IFFT block 308 and an overlap/add block 310 for each channel to provide the channel output. Alternatively, the IFFT block 308 and the overlap/add block 310 may be reused for each channel, depending on the implementation. In the illustrated example, the IFFT block 308(1) and the overlap/add block 310(1) are shown with solid lines while the IFFT blocks 308(2) through 308(C) and the overlap/add blocks 310(2) through 310(C) are shown in phantom because, in other embodiments, the IFFT block 308 and the overlap/add block 310 may be shared or reused for each channel.

In some example embodiments, the frequency-domain beamforming circuit 118 may operate in a bypass mode in which some or all Fast Fourier Transform (FFT) operations performed by the FFT blocks 302(1)-302(B) may be skipped. In example embodiments, the bypass mode may be used when a source block that provides the in-phase and quadrature (I-Q) data samples for one or more transmit beams delivers the data directly in the frequency domain rather than in the time domain. In such example embodiments, the frequency-domain beamforming circuit 118 may receive frequency-domain beam data corresponding to one or more beams and may route the frequency-domain beam data directly to the frequency-domain vector multiplication block 304 without performing an FFT operation for those beams. In example embodiments, the FFT blocks 302(1)-302(B) associated with the beams receiving frequency-domain data may be disabled, bypassed, or otherwise omitted from the signal path, while other FFT blocks 302(1)-302(B) may remain active for beams that continue to receive time-domain data.

As a nonlimiting example, a satellite communication transmitter or a portable wireless device may include a baseband processing block that performs modulation, pulse shaping, and spectral mapping in the frequency domain and outputs frequency-domain beam data corresponding to multiple transmit beams. In example embodiments, the frequency-domain beamforming circuit 118 may receive this frequency-domain beam data directly from the baseband processing block and may bypass the FFT blocks 302(1)-302(B) for those beams, while continuing to apply beam-specific phase shifts, fractional delays, or channelization filtering using the frequency-domain vector multiplication block 304. In example embodiments, other beams generated from time-domain sources may still be processed using the FFT blocks 302(1)-302(B), allowing mixed operation in which some beams use the bypass mode and other beams use time-domain-to-frequency-domain conversion. Other example embodiments may use different source blocks, different combinations of bypassed and non-bypassed beams, or different allocation of FFT resources, while still operating within the scope of the frequency-domain beamforming circuit 118 illustrated in FIG. 3.

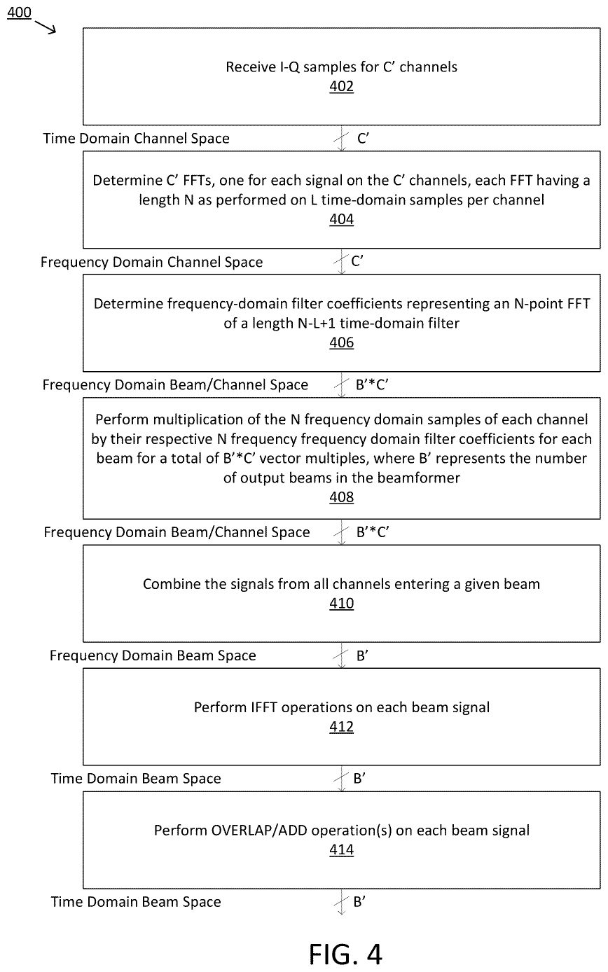

FIG. 4 depicts a flow diagram of a method 400 of beamforming for receiving, in accordance with certain embodiments of the present disclosure. The method 400 may be implemented in a field-programmable gate array (FPGA), an application-specific integrated circuit (ASIC), a programmable logic circuit, a processor circuit, or any combination thereof to perform the frequency-domain beamforming operations. In some embodiments, the beamforming operations may be defined in processor-readable instructions, which may be upgraded or altered and which may be executed by one or more processors, FPGAs, ASICs, programmable logic circuits, or other circuits of the frequency-domain beamformer circuit 118 to process the I-Q data samples.

At 402, the method 400 may include receiving I-Q data samples for C′ channels. The I-Q data samples may be received by the frequency-domain beamformer circuit 118 from the signal processing circuit 126, from the processor 124, from the analog front end 102, or from the memory 120. The I-Q data samples are received in the time domain channel space.

At 404, the method 400 may include determining C′ FFTs, one for each channel, where each FFT has a length N as performed on L time-domain samples per channel. The C′ FFTs may be computed by the frequency-domain beamformer circuit 118. The C′ FFTs are provided to a multiplication filter in the frequency-domain channel space.

At 406, the method 400 may include determining frequency-domain filter coefficients representing an N point DFT of a length N−L+1 time domain filter. The frequency-domain filter coefficients may include phase shift, fractional delays, and other values that may be used to configure one or more filters. The frequency-domain filter coefficients may be calculated on the fly or may be retrieved from the coefficient storage 122 in the memory 120. In this implementation, there may be one set of filter coefficients for each beam.

At 408, the method 400 may include performing a multiplication of the N frequency-domain samples of each channel c′ᵢ, i=1, . . . , C′ by their respective N frequency-domain filter coefficients for each beam b′ᵢ, i=1, . . . , B′ for a total of B′C′ vector multiplies, where B′ represents the number of receive beams in the beamformer. In this implementation, the frequency-domain beamformer circuit 118 may replicate the FFT outputs to each separate frequency-domain filter so there is only one FFT multiplication operation per channel and not per beam in the data path, instead of multiple FFTs per channel and per beam as in the prior art. The frequency-domain beamformer circuit 118 may perform the multiplications in the frequency-domain beam/channel space.

At 410, the method 400 may include combining the signals from all channels entering a given beam. In an example, the outputs of the multiplication operations may be organized by channel and combined. The frequency-domain beamformer circuit 118 may take the filter outputs for each channel entering a given beam and combine them. The resulting outputs may include streams of beam data in the frequency-domain beam space.

At 412, the method 400 may include performing an IFFT operation on each beam signal. The frequency-domain beamformer circuit 118 may perform the IFFT operations to produce a beam signal for each beam in the time domain channel space. The combined frequency-domain vector multiplication output is combined for each beam so that only one IFFT operation is performed per beam in the data path.

At 414, the method 400 may include performing an overlap/add operation on each beam signal. In the overlap/add operation, the output stream of beam data of a current segment of the beam data is added to the output stream of beam data of a previous segment of the beam data. In other words, the newly processed data segment is added to the previous segment to produce time-domain beam data streams in the time domain beam space.

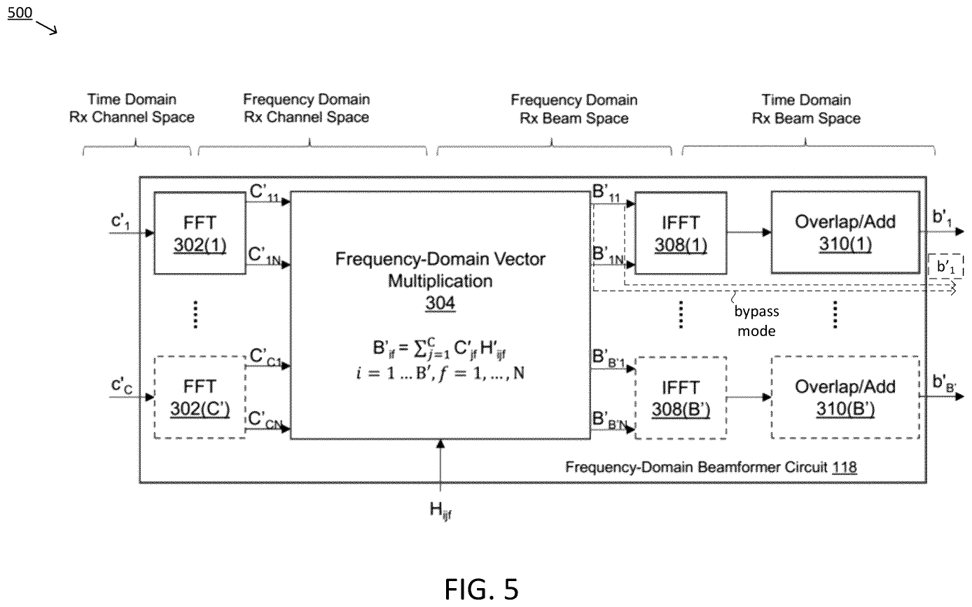

The receive process for the frequency-domain beam former circuit 118 is similar to the transmit process and similar processor flop savings can be achieved by sharing FFT calculations and by grouping the outputs prior to performing IFFT and overlap/add processes. An example of the receive process is described below with respect to FIG. 5.

FIG. 5 depicts a block diagram of a system 500 including functional elements of a frequency-domain beamforming circuit 118 configured for reception, in accordance with certain embodiments of the present disclosure. The system 500 may include a frequency-domain beamformer circuit 118 including one or more inputs to receive I-Q time-domain samples from C′ channels. The frequency-domain beamformer circuit 118 may include an FFT block 302. In some embodiments, the frequency-domain beamformer circuit 118 may include an FFT block 302 for each channel. Alternatively, the FFT block 302 may be reused for each channel, depending on the implementation. In the illustrated example, the FFT block 302(1) is shown with solid lines while the FFT blocks 302(2) through 302(C′) are shown in phantom because, in other embodiments, the FFT block 302 may be shared or reused for each channel.

Each FFT 302 may operate on segments of length L from the stream of I-Q samples. The FFT may have a length N including L time-domain samples per beam. The FFT 302 may provide the output to the frequency-domain vector multiplication block 304

The frequency-domain vector multiplication block 304 may receive frequency-domain filter coefficients H_{ijf} from a memory 120, a processor 124, or another source and may perform vector multiplication operations for N frequency-domain samples of each channel c′ᵢ, i=1, . . . , C′ by their respective N frequency-domain filter coefficients for each beam b′ᵢ, i=1, . . . , B′ for a total of B′C′ vector multiply operations, where B′ represents the number of receive beams of the frequency-domain beamforming circuit 118.

The frequency-domain beamformer circuit 118 may include a plurality of IFFT blocks 308(1) through 308(B′), each of which is configured to perform an inverse FFT operation on the beam output stream from one of the frequency-domain vector multiplier 304. The output of the IFFT block 308 may be fed to an overlap/add block 310 that may perform the overlap and add operation for each beam to produce the time-domain beam signal in the time domain transmit channel space.

In some embodiments, the frequency-domain beamformer circuit 118 may include an IFFT block 308 and an overlap/add block 310 for each beam to provide the beam output. In the illustrated example, the IFFT block 308(1) and the overlap-add block 310(1) are shown with solid lines while the IFFT blocks 308(2) through 308(B′) and the overlap-add block 310(2) through 310(B′) are shown in phantom because, in other embodiments, the IFFT block 308 and the overlap/add block 310 may be shared or reused for each beam.

In some example embodiments, the frequency-domain beamforming circuit 118 may operate in a bypass mode in which some or all inverse Fast Fourier Transform (IFFT) blocks 308(1)-308(B′) and overlap/add blocks 310(1)-310(B′) may be skipped when a sink block is configured to receive frequency-domain data. In example embodiments, the frequency-domain beamforming circuit 118 may receive in-phase and quadrature (I-Q) samples for a plurality of receive channels and may perform FFT operations using the FFT blocks 302(1)-302(C′) to generate frequency-domain channel signals. The frequency-domain vector multiplication block 304 may multiply the frequency-domain channel signals by frequency-domain filter coefficients H_{ijf} and may combine the resulting products to produce frequency-domain beam signals B′_{if} in the frequency-domain receive beam space. In example embodiments in which the sink block is configured to consume frequency-domain beam data, the frequency-domain beamforming circuit 118 may provide the frequency-domain beam signals directly to the sink block without performing inverse FFT or overlap/add processing.

As a nonlimiting example, a receiver in a satellite communication system or a phased-array wireless device may include a downstream digital signal processing block that performs beam-space processing, demodulation, or interference cancellation directly in the frequency domain. In example embodiments, the frequency-domain beamforming circuit 118 may provide frequency-domain beam signals directly to the downstream processing block and may bypass the IFFT blocks 308(1)-308(B′) and the overlap/add blocks 310(1)-310(B′). In example embodiments, other systems may require time-domain beam signals and may therefore enable the inverse FFT and overlap/add processing. Other example embodiments may use different sink blocks, different combinations of bypassed and non-bypassed beams, or different operating modes, while still operating within the scope of the frequency-domain beamforming circuit 118 illustrated in FIG. 5.

In the example embodiments illustrated herein, the bypass of one or more Fast Fourier Transform (FFT) blocks (e.g., FIG. 3) or inverse FFT (IFFT) and overlap/add blocks (e.g., FIG. 5) is shown for purposes of clarity and explanation. It should be understood, however, that these illustrations are non-limiting. In various embodiments, the frequency-domain beamforming circuit may bypass any subset of the FFT blocks, IFFT blocks, and/or overlap/add blocks, including bypassing a single such block, multiple such blocks, or all such blocks, depending on whether corresponding data is provided or consumed in the frequency domain. Accordingly, the depicted bypass of a particular transform block does not imply that bypass capability is restricted to that block alone, and embodiments include configurations in which bypass functionality is selectively applied on a per-beam, per-channel, or per-path basis.

In conjunction with the systems, circuits, and methods described above with respect to FIGS. 1-5, a wireless communication system is disclosed that may include frequency-domain beamforming circuitry that is configured to utilize a shared FFT for per beam or per channel FFT operation and that groups outputs of the multiplication filter operations to perform per channel or per beam IFFT and overlap/add operations. By sharing operations, power consumption and overall complexity are reduced. Moreover, the overall number of operations is reduced, increasing the processing speed of the system.

Various embodiments may be described in the following clauses:

1. A system, comprising:
a first interface coupled to an analog front end;
a second interface coupled to a signal processing circuit; and
a frequency-domain beamforming circuit coupled to the first interface and the second interface, the frequency-domain beamforming circuit configured to:
receive in-phase and quadrature (I-Q) samples for B beams or C′ channels;
determine a Discrete Fourier transform (DFT) for the I-Q samples for each beam or for each channel to determine frequency-domain vector signals through a Fast Fourier Transform (FFT) or any variant thereof;
multiply frequency-domain filter coefficients and the frequency-domain vector signals to produce vector output signals;
combine the vector output signals entering a given channel or a given beam to produce a channel signal or a beam signal;
determine an inverse DFT for the channel signal or the beam signal to produce a time-domain signal through an inverse FFT (IFFT) or any variant thereof;
perform an overlap/add operation on the time-domain signal to produce an output signal; and
provide the output signal to one of the first interface or the second interface.

2. The system of clause 1, wherein, in a transmit mode, the frequency-domain beamforming circuit is configured to:
receive the I-Q samples for the B beams from one or more of a memory or the second interface;
determine the FFT for each signal on the B beams, each FFT having a length N as performed on L time-domain samples per beam;
determine the frequency-domain filter coefficients representing an N point FFT of a length N−L+1; and
wherein multiplying the frequency-domain filter coefficients includes performing a multiplication of the N frequency-domain samples of each beam B by respective N frequency-domain filter coefficients for each channel for a total of BC vector multiplies.

3. The system of clause 1, wherein the frequency-domain beamforming circuit is configured to calculate the frequency-domain filter coefficients.

4. The system of clause 2, wherein, in the transmit mode, the frequency-domain beamforming circuit is to receive frequency-domain beam data for at least one of the B beams from a source block, and wherein the frequency-domain beamforming circuit is further to bypass determining the FFT for the frequency-domain beam data for the at least one of the B beams and to provide the frequency-domain beam data directly to the frequency-domain filter multiplication.

5. The system of clause 2, wherein the frequency-domain beamforming circuit is configured to:
combine the vector output signals corresponding to each of the B beams entering the given channel to produce a channel signal representing each output channel;
perform the IFFT on each of the channel signals for each channel output to produce a time-domain channel signal for each channel output;
perform the overlap/add operation on the time-domain channel signal for each channel output to produce the output signal; and provide the output signal to the first interface.

6. The system of clause 1, wherein, in a receive mode, the frequency-domain beamforming circuit is configured to:
receive the I-Q samples for the C′ channels from the first interface;
determine the FFT for each signal on the C′ channels, each FFT having a length N as performed on L time-domain samples per channel;
determine the frequency-domain filter coefficients representing an N point discrete Fourier transform of a length N−L+1; and
wherein multiplying the frequency-domain filter coefficients includes performing a multiplication of the N frequency-domain samples of each channel by respective N frequency-domain filter coefficients for each beam B′ for a total of B′C′ vector multiplies.

7. The system of clause 6, wherein the frequency-domain beamforming circuit is configured to:
combine the vector output signals corresponding to each of the C′ channels entering the given beam to produce a beam signal representing each output beam;
perform the IFFT on the beam signal for each output beam to produce a time-domain beam signal for each beam output;
perform the overlap/add operation on the time-domain beam signal for each beam output to produce the output signal; and
provide the output signal to the second interface.

8. The system of clause 1, wherein, in a receive mode, the frequency-domain beamforming circuit is configured to replicate the frequency-domain vector signals from the output of each of the FFTs to each of a plurality of frequency-domain filters such that the frequency-domain beamforming circuit performs one FFT per channel.

9. The system of clause 6, wherein, in the receive mode, the frequency-domain beamforming circuit is to provide frequency-domain beam data to a sink block, and wherein the frequency-domain beamforming circuit is further to bypass performing the IFFT and the overlap/add operation for at least one of the output beams when the sink block is to receive frequency-domain data.

10. The system of clause 1, wherein, in a transmit mode, the frequency-domain beamforming circuit is configured to:
sum the frequency-domain vector signals on a per channel basis in a frequency domain to produce a summed signal for each channel; and
perform the IFFT on the summed signal for each channel.

11. A method of determining an output signal including one of a channel signal or a beam signal, the method comprising:
receiving, at a frequency-domain beamforming circuit, in-phase and quadrature (I-Q) samples for B beams or C′ channels at one of a first interface coupled to an analog front end or a second interface coupled to a processing circuit;
determining a Discrete Fourier transform (DFT) for the I-Q samples for each beam or for each channel to determine frequency-domain vector signals through a Fast Fourier Transform (FFT) or any fast variant thereof,
multiplying frequency-domain filter coefficients and the frequency-domain vector signals to produce vector output signals;
combining the vector output signals entering a given channel or a given beam to produce a channel signal or a beam signal;
determining an inverse DFT for the channel signal or the beam signal to produce a time-domain signal through an inverse FFT (IFFT) or any fast variant thereof,
performing an overlap/add operation on the time-domain signal to produce the output signal; and
providing the output signal to one of the first interface or the second interface.

12. The method of clause 11, wherein, in a transmit mode, the method further comprises: receiving the I-Q samples for B beams from one or more of a memory or the second interface;
determining the FFT for each signal on the B beams, each FFT having a length N as performed on L time-domain samples per beam;
determining the frequency-domain filter coefficients representing an N point discrete Fourier transform of a length N−L+1 filter by retrieving the frequency-domain filter coefficients from the memory or by calculating the frequency-domain filter coefficients; and
wherein multiplying the frequency-domain filter coefficients includes performing a multiplication of the N frequency-domain samples of each beam by respective N frequency-domain filter coefficients for each channel for a total of BC vector multiplies.

13. The method of clause 12, further comprising:
combining the vector output signals corresponding to each of the B beams entering the given channel to produce a channel signal representing each output channel;
performing the IFFT on each of the channel signals for each channel output to produce a time-domain channel signal for each channel output;
performing the overlap-add operation on the time-domain channel signal for each channel output to produce the output signal; and
providing the output signal to the first interface.

14. The method of clause 11, wherein, in a receive mode, the method comprises:
receiving the I-Q samples for the C′ channels from the first interface;
determining the FFT for each signal on the C′ channels, each FFT having a length N as performed on L time-domain samples per channel;
determining the frequency-domain filter coefficients representing an N point discrete Fourier transform of a length N−L+1 filter; and
wherein multiplying the frequency-domain filter coefficients includes performing a multiplication of the N frequency-domain samples of each channel by respective N frequency-domain filter coefficients for each beam B′ for a total of B′C′ vector multiplies.

15. The method of clause 14, further comprising:
combining the vector output signals corresponding to each of the C′ channels entering the given beam to produce a beam signal representing each output beam;
performing the IFFT on the beam signal for each output beam to produce a time-domain beam signal for each beam output;
performing the overlap-add operation on the time-domain beam signal for each beam output to produce the output signal; and
providing the output signal to the second interface.

16. A system comprising:
a first interface coupled to an analog front end;
a second interface coupled to a signal processing circuit; and
a frequency-domain beamforming circuit coupled to the first interface and the second interface, the frequency-domain beamforming circuit configured to:
receive in-phase and quadrature (I-Q) samples for B beams or C′ channels;
determine a Discrete Fourier transform (DFT) for the I-Q samples for each beam or for each channel to determine frequency-domain vector signals;
multiply frequency-domain filter coefficients and the frequency-domain vector signals to produce vector output signals;
combine the vector output signals entering a given channel or a given beam to produce a channel signal or a beam signal;
determine an inverse FFT (IFFT) for the channel signal or the beam signal to produce a time-domain signal;
perform an overlap/add operation on the time-domain signal to produce an output signal;
provide the output signal to one of the first interface or the second interface;
wherein, in a receive mode, the frequency-domain beamforming circuit is configured to replicate the frequency-domain vector signals from the output of each of the FFTs to each of a plurality of frequency-domain filters such that the frequency-domain beamforming circuit performs one FFT per channel; and
wherein, in a transmit mode, the frequency-domain beamforming circuit is configured to perform one FFT operation per beam, sum the frequency-domain vector signals on a per element basis in the frequency domain, and reuse the IFFT for each channel.

17. The system of clause 16, wherein, in a transmit mode, the frequency-domain beamforming circuit is configured to:
receive the I-Q samples for the B beams from one or more of a memory or the second interface;
determine the FFT for each signal on the B beams, each FFT having a length N as performed on L time-domain samples per beam;
determine the frequency-domain filter coefficients corresponding to an N point FFT of a length N−L+1 filter, the frequency-domain beamforming circuit determines the frequency-domain filter coefficients by one of calculating the frequency-domain filter coefficients or retrieving the frequency-domain filter coefficients from a memory; and
multiplying the frequency-domain filter coefficients by performing a multiplication of the N frequency-domain samples of each beam by respective N frequency-domain filter coefficients for each channel for a total of BC vector multiplies.

18. The system of clause 17, wherein the frequency-domain beamforming circuit is configured to:
combine the vector output signals corresponding to each of the B beams entering the given channel to produce a channel signal representing each output channel;
perform the IFFT on each of the channel signals for each channel output to produce a time-domain channel signal for each channel output;
perform the overlap-add operation on the time-domain channel signal for each channel output to produce the output signal; and
provide the output signal to the first interface.

19. The system of clause 16, wherein, in a receive mode, the frequency-domain beamforming circuit is configured to:
receive the I-Q samples for the C′ channels from the first interface;
determine the FFT for each of the C′ channels, each FFT having a length N as performed on L time-domain samples per channel;
determine the frequency-domain filter coefficients representing an N point FFT of a length N−L+1; and
wherein multiplying the frequency-domain filter coefficients includes performing a multiplication of the N frequency-domain samples of each channel by respective N frequency-domain filter coefficients for each beam B′ for a total of B′C′ vector multiplies.

20. The system of clause 19, wherein the frequency-domain beamforming circuit is configured to:
combine the vector output signals corresponding to each of the C′ channels entering the given beam to produce a beam signal representing each output beam;
perform the IFFT on the beam signal for each output beam to produce a time-domain beam signal for each beam output;
perform the overlap-add operation on the time-domain beam signal for each beam output to produce the output signal; and
provide the output signal to the second interface.

21. A method for operating portable communications device of any of clauses 1-20.

22. A non-transitory computer-readable storage medium including instructions that, when executed by at least one processor, cause the at least one processor to perform communications using the portable communications device of any of clauses 1-20.

23. A satellite-based communication system including at least one portable communications device of any of clauses 1-20.

24. The system of clause 1, wherein the frequency-domain beamforming circuit is configured to retrieve the frequency-domain filter coefficients from a memory.

25. The system of clause 1, wherein, in a transmit mode, the frequency-domain beamforming circuit is configured to perform one FFT operation per beam.

Other variations are possible as well within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) can be performed under at least partial control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms such as “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system, comprising:
a first interface coupled to an analog front end;
a second interface coupled to a signal processing circuit; and
a frequency-domain beamforming circuit coupled to the first interface and the second interface, the frequency-domain beamforming circuit configured to:
receive in-phase and quadrature (I-Q) samples for B beams or C′ channels;
determine a Discrete Fourier transform (DFT) for the I-Q samples for each beam or for each channel to determine frequency-domain vector signals through a Fast Fourier Transform (FFT) or any variant thereof;
multiply frequency-domain filter coefficients and the frequency-domain vector signals to produce vector output signals;
combine the vector output signals entering a given channel or a given beam to produce a channel signal or a beam signal;
determine an inverse DFT for the channel signal or the beam signal to produce a time-domain signal through an inverse FFT (IFFT) or any variant thereof;
perform an overlap/add operation on the time-domain signal to produce an output signal; and
provide the output signal to one of the first interface or the second interface.

2. The system of claim 1, wherein, in a transmit mode, the frequency-domain beamforming circuit is configured to:
receive the I-Q samples for the B beams from one or more of a memory or the second interface;
determine the FFT for each signal on the B beams, each FFT having a length N as performed on L time-domain samples per beam;
determine the frequency-domain filter coefficients representing an N point FFT of a length N−L+1; and
wherein multiplying the frequency-domain filter coefficients includes performing a multiplication of the N frequency-domain samples of each beam B by respective N frequency-domain filter coefficients for each channel for a total of BC vector multiplies.

3. The system of claim 1, wherein the frequency-domain beamforming circuit is configured to calculate the frequency-domain filter coefficients.

4. The system of claim 2, wherein, in the transmit mode, the frequency-domain beamforming circuit is to receive frequency-domain beam data for at least one of the B beams from a source block, and wherein the frequency-domain beamforming circuit is further to bypass determining the FFT for the frequency-domain beam data for the at least one of the B beams and to provide the frequency-domain beam data directly to the frequency-domain filter multiplication.

5. The system of claim 2, wherein the frequency-domain beamforming circuit is configured to:
combine the vector output signals corresponding to each of the B beams entering the given channel to produce a channel signal representing each output channel;
perform the IFFT on each of the channel signals for each channel output to produce a time-domain channel signal for each channel output;
perform the overlap/add operation on the time-domain channel signal for each channel output to produce the output signal; and
provide the output signal to the first interface.

6. The system of claim 1, wherein, in a receive mode, the frequency-domain beamforming circuit is configured to:
receive the I-Q samples for the C′ channels from the first interface;
determine the FFT for each signal on the C′ channels, each FFT having a length N as performed on L time-domain samples per channel;
determine the frequency-domain filter coefficients representing an N point discrete Fourier transform of a length N−L+1; and
wherein multiplying the frequency-domain filter coefficients includes performing a multiplication of the N frequency-domain samples of each channel by respective N frequency-domain filter coefficients for each beam B′ for a total of B′C′ vector multiplies.

7. The system of claim 6, wherein the frequency-domain beamforming circuit is configured to:
combine the vector output signals corresponding to each of the C′ channels entering the given beam to produce a beam signal representing each output beam;
perform the IFFT on the beam signal for each output beam to produce a time-domain beam signal for each beam output;
perform the overlap/add operation on the time-domain beam signal for each beam output to produce the output signal; and
provide the output signal to the second interface.

8. The system of claim 1, wherein, in a receive mode, the frequency-domain beamforming circuit is configured to replicate the frequency-domain vector signals from the output of each of the FFTs to each of a plurality of frequency-domain filters such that the frequency-domain beamforming circuit performs one FFT per channel.

9. The system of claim 6, wherein, in the receive mode, the frequency-domain beamforming circuit is to provide frequency-domain beam data to a sink block, and wherein the frequency-domain beamforming circuit is further to bypass performing the IFFT and the overlap/add operation for at least one of the output beams when the sink block is to receive frequency-domain data.

10. The system of claim 1, wherein, in a transmit mode, the frequency-domain beamforming circuit is configured to:
sum the frequency-domain vector signals on a per channel basis in a frequency domain to produce a summed signal for each channel; and
perform the IFFT on the summed signal for each channel.

11. A method of determining an output signal including one of a channel signal or a beam signal, the method comprising:
receiving, at a frequency-domain beamforming circuit, in-phase and quadrature (I-Q) samples for B beams or C′ channels at one of a first interface coupled to an analog front end or a second interface coupled to a processing circuit;
determining a Discrete Fourier transform (DFT) for the I-Q samples for each beam or for each channel to determine frequency-domain vector signals through a Fast Fourier Transform (FFT) or any fast variant thereof,
multiplying frequency-domain filter coefficients and the frequency-domain vector signals to produce vector output signals;
combining the vector output signals entering a given channel or a given beam to produce a channel signal or a beam signal;
determining an inverse DFT for the channel signal or the beam signal to produce a time-domain signal through an inverse FFT (IFFT) or any fast variant thereof,
performing an overlap/add operation on the time-domain signal to produce the output signal; and
providing the output signal to one of the first interface or the second interface.

12. The method of claim 11, wherein, in a transmit mode, the method further comprises:
receiving the I-Q samples for B beams from one or more of a memory or the second interface;
determining the FFT for each signal on the B beams, each FFT having a length N as performed on L time-domain samples per beam;
determining the frequency-domain filter coefficients representing an N point discrete Fourier transform of a length N−L+1 filter by retrieving the frequency-domain filter coefficients from the memory or by calculating the frequency-domain filter coefficients; and
wherein multiplying the frequency-domain filter coefficients includes performing a multiplication of the N frequency-domain samples of each beam by respective N frequency-domain filter coefficients for each channel for a total of BC vector multiplies.

13. The method of claim 12, further comprising:
combining the vector output signals corresponding to each of the B beams entering the given channel to produce a channel signal representing each output channel;
performing the IFFT on each of the channel signals for each channel output to produce a time-domain channel signal for each channel output;
performing the overlap-add operation on the time-domain channel signal for each channel output to produce the output signal; and
providing the output signal to the first interface.

14. The method of claim 11, wherein, in a receive mode, the method comprises:
receiving the I-Q samples for the C′ channels from the first interface;
determining the FFT for each signal on the C′ channels, each FFT having a length N as performed on L time-domain samples per channel;
determining the frequency-domain filter coefficients representing an N point discrete Fourier transform of a length N−L+1 filter; and
wherein multiplying the frequency-domain filter coefficients includes performing a multiplication of the N frequency-domain samples of each channel by respective N frequency-domain filter coefficients for each beam B′ for a total of B′C′ vector multiplies.

15. The method of claim 14, further comprising:
combining the vector output signals corresponding to each of the C′ channels entering the given beam to produce a beam signal representing each output beam;
performing the IFFT on the beam signal for each output beam to produce a time-domain beam signal for each beam output;
performing the overlap-add operation on the time-domain beam signal for each beam output to produce the output signal; and
providing the output signal to the second interface.

16. A system comprising:
a first interface coupled to an analog front end;
a second interface coupled to a signal processing circuit; and
a frequency-domain beamforming circuit coupled to the first interface and the second interface, the frequency-domain beamforming circuit configured to:
receive in-phase and quadrature (I-Q) samples for B beams or C′ channels;
determine a Discrete Fourier transform (DFT) for the I-Q samples for each beam or for each channel to determine frequency-domain vector signals;
multiply frequency-domain filter coefficients and the frequency-domain vector signals to produce vector output signals;
combine the vector output signals entering a given channel or a given beam to produce a channel signal or a beam signal;
determine an inverse FFT (IFFT) for the channel signal or the beam signal to produce a time-domain signal;
perform an overlap/add operation on the time-domain signal to produce an output signal;
provide the output signal to one of the first interface or the second interface;
wherein, in a receive mode, the frequency-domain beamforming circuit is configured to replicate the frequency-domain vector signals from the output of each of the FFTs to each of a plurality of frequency-domain filters such that the frequency-domain beamforming circuit performs one FFT per channel; and
wherein, in a transmit mode, the frequency-domain beamforming circuit is configured to perform one FFT operation per beam, sum the frequency-domain vector signals on a per element basis in the frequency domain, and reuse the IFFT for each channel.

17. The system of claim 16, wherein, in a transmit mode, the frequency-domain beamforming circuit is configured to:
receive the I-Q samples for the B beams from one or more of a memory or the second interface;
determine the FFT for each signal on the B beams, each FFT having a length N as performed on L time-domain samples per beam;
determine the frequency-domain filter coefficients corresponding to an N point FFT of a length N−L+1 filter, the frequency-domain beamforming circuit determines the frequency-domain filter coefficients by one of calculating the frequency-domain filter coefficients or retrieving the frequency-domain filter coefficients from a memory; and
multiplying the frequency-domain filter coefficients by performing a multiplication of the N frequency-domain samples of each beam by respective N frequency-domain filter coefficients for each channel for a total of BC vector multiplies.

18. The system of claim 17, wherein the frequency-domain beamforming circuit is configured to:
combine the vector output signals corresponding to each of the B beams entering the given channel to produce a channel signal representing each output channel;
perform the IFFT on each of the channel signals for each channel output to produce a time-domain channel signal for each channel output;
perform the overlap-add operation on the time-domain channel signal for each channel output to produce the output signal; and
provide the output signal to the first interface.

19. The system of claim 16, wherein, in a receive mode, the frequency-domain beamforming circuit is configured to:
receive the I-Q samples for the C′ channels from the first interface;
determine the FFT for each of the C′ channels, each FFT having a length N as performed on L time-domain samples per channel;
determine the frequency-domain filter coefficients representing an N point FFT of a length N−L+1; and
wherein multiplying the frequency-domain filter coefficients includes performing a multiplication of the N frequency-domain samples of each channel by respective N frequency-domain filter coefficients for each beam B′ for a total of B′C′ vector multiplies.

20. The system of claim 19, wherein the frequency-domain beamforming circuit is configured to:
combine the vector output signals corresponding to each of the C′ channels entering the given beam to produce a beam signal representing each output beam;
perform the IFFT on the beam signal for each output beam to produce a time-domain beam signal for each beam output;
perform the overlap-add operation on the time-domain beam signal for each beam output to produce the output signal; and
provide the output signal to the second interface.
